(19) United States
(12) Patent Application Publication
(10) Pub. No.: US 2014/0238304 A1
(43) Pub. Date: Aug. 28, 2014

(54) METHOD AND APPARATUS FOR MONITORING A MILKING PROCESS

(71) Applicant: LELY PATENT N.V., Maassluis (NL)

(72) Inventor: Allan Walter WILSON, HAMILTON (NZ)

(73) Assignee: LELY PATENT N.V., Maassluis (NL)

(21) Appl. No.: 14/271,482

(22) Filed: May 7, 2014

Related U.S. Application Data
(63) Continuation of application No. PCT/NL2012/050640, filed on Sep. 13, 2012.

(30) Foreign Application Priority Data
Nov. 7, 2011 (NL) 2007732

(51) Int. Cl. A01J 5/007

(52) U.S. Cl. CPC A01J 5/007
USPC 119/14.02; 119/14.47; 119/14.08

(57) ABSTRACT

A method of monitoring a milking process by a milking apparatus with a teatcup with a pulsation space and a pulsation airline configured to deliver varying levels of pressure to the pulsation space, including measuring at least one property of a vibrational signal within the airline with a vibration sensor; comparing a value of the measured property with a reference value; and determining a condition of the milking process based on the comparison. The vibrational signal can be a sound signal from to the displacement of air into and out of the pulsation space. This sound in the airline correlates to the extent to which a teat has entered a teatcup, and is a good indication of the connection of the teatcup to that teat. The sound is furthermore a cleaner signal than a sound signal in a milkline. Also provided is a robotic automatic milking implement incorporating the method.

### CROSS REFERENCE TO RELATED APPLICATIONS

This application is a continuation of PCT application number PCT/NL2012/050640 filed on 13 Sep. 2012, which claims priority from Netherlands application number 2007732 filed on 7 Nov. 2011. Both applications are hereby incorporated by reference in their entireties.

### BACKGROUND OF THE INVENTION

1. Field of the Invention

The invention relates generally to a method and apparatus for monitoring a milking process, and more particularly, to monitoring a milking process by measuring at least one property of a vibrational signal within an airline.

2. Description of the Related Art

In any milking system, it is important to ensure that teatcups are properly connected to the teats of animals being milked. Improper connection may result in inefficient milking—if any milk at all may be extracted—and cause damage to the udder. If a teatcup becomes completely disconnected, there is also a risk that extraneous material within the milking environment will be sucked into the milk delivery system, which is highly undesirable.

The ability to detect these problems is especially important in an automated milking system, such as those controlled by a robot, where operators are not always present to observe an improper connection and readjust the teatcup.

One method for doing so measures sound within the milking line and compares these measurements with predetermined reference values to determine whether present conditions within the line indicate that the teatcup is correctly connected to the teat. Document EP-0953829A provides an example of one such method based on this principle.

Such methods suffer limitations due to the nature of the environment within the milking line. In particular, the passage of liquid within the line creates significant levels of interference which makes obtaining consistent and accurate measurements difficult. Connection of the milking line to other elements within the milking plant also introduces other sources of noise.

Furthermore, such methods require placement of the sensor for measuring sound within the milking line between the teatcups and milk receiver. The environment surrounding the teatcups is harsh, for example due to exposure to liquid (including cleaning chemicals), impact, and variation in temperature. Positioning of the sensor at this point is also not conducive to the generally desirable objective of minimising bulk and weight to the milking implement.

### BRIEF SUMMARY OF THE INVENTION

It is an object of the invention to address the foregoing problems or at least to provide the public with a useful choice.

All references, including any patents or patent applications, cited in this specification are hereby incorporated by reference. No admission is made that any reference constitutes prior art. The discussion of the reference states what their authors assert, and the applicants reserve the right to challenge the accuracy and pertinency of the cited documents. It will be clearly understood that, although a number of prior art publications are referred to herein, this reference does not constitute an admission that any of these documents forms parts of the common general knowledge in the art, in New Zealand or in any other country.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

Further aspects and advantages of the present invention will become apparent from the ensuing description which is given by way of example only.

According to one aspect of the present invention there is provided a method of monitoring a milking process, the milking process performed by a milking apparatus including at least one teatcup with a pulsation space and at least one pulsation airline configured to deliver varying levels of pressure to the pulsation space, the method characterised by the steps of:
measuring at least one property of a vibrational signal within the airline with a vibration sensor;
comparing a value of the measured property with a reference value; and determining a condition of the milking process based on the comparison.

According to another aspect of the present invention there is provided a control device for monitoring a milking process, the milking process performed by a milking apparatus including at least one teatcup with a pulsation space and at least one pulsation airline configured to deliver varying levels of pressure to the pulsation space, the device including:
a vibration sensor configured to measure at least one property of vibrations within the airline; and
at least one processor configured to:
compare a value of the measured property with a reference value; and
determine a condition of the milking process based on the comparison.

According to another aspect of the present invention there is provided a robotic automatic milking implement configured to perform a milking process, the implement including:
at least one teatcup configured to receive a teat of a milking animal, wherein the teatcup includes a pulsation space;
at least one airline configured to deliver varying levels of pressure to the pulsation space of the teatcup;
a robot arm configured to connect the teatcup to the teat; and
a vibration sensor configured to measure at least one property of vibrations within the airline; and
at least one processor configured to:
compare a value of the measured property with a reference value; and
determine a condition of the milking process based on the comparison.

It is envisaged that the vibrational signal may be an acoustic signal within the airline.

The airline may provide a much cleaner source of sound within the teatcup than the milking line. Variation in noise levels, particularly during certain phases of the pulsation cycle, may be attributed to variation in airflow through the teatcup with a greater level of confidence than in previously known systems.

It is envisaged that the pulsation space may be the space between a teatcup shell and teatcup liner, as known in the art. The pulsation space may also act as a “sounding” diaphragm in order to provide a large signal to noise ratio within the airline.

By measuring vibrations in the airline the sensor may also be positioned away from the point of milk extraction, minimising sensor requirements with regard to withstanding environmental effects and reducing clutter. Furthermore, activity within the airline is not as constrained by hygiene regulations as the milking line.

In a preferred embodiment the condition is one of the teatcup being disconnected from a teat of the milking animal, or the teatcup being incorrectly fitted to a teat of a milking animal.

It should be appreciated that determining the condition may be achieved in a number of ways.

Preferably determining the condition includes comparing an amplitude of the measured property with the reference value.

However, in another embodiment determining the condition may include comparing deviation of the value of the measured property over time with the reference value.

Alternatively, determining the condition may include comparing the rate of change of the measured property over time with the reference value.

The varying levels of pressure delivered to the pulsation space are commonly known as a pulsation cycle in which the pulsation space is alternately exposed to atmospheric pressure and a negative pressure commonly referred to as “vacuum”. Within this cycle, there are a number of phases characterised by the level of pressure and direction of airflow. It is envisaged that in a preferred embodiment the invention includes determining a phase of one of the milking process or a pulsation phase.

It is envisaged that the phase may be determined by comparing the value of the measured property with a predetermined threshold.

Alternatively, or in combination with other methods, the phase may be determined using a signal associated with a pulsator configured to control the level of pressure within the airline.

Preferably the property may be measured during at least one selected phase.

Specifically, it is envisaged that the property may be measured during a phase in which the airline is exposed to atmosphere.

Further, the expected characteristics of the vibrational signal may vary between phases. As such, the phase in which the property is measured may be used to determine the reference value to be used in the comparison.

In a preferred embodiment the vibration sensor is at least one of a piezoelectric transducer and a microphone.

Preferably, the property of the vibrational signal is an average sound pressure level or a peak sound pressure level. In particular, it is envisaged that this may be measured during a resting phase and/or a milking phase of a pulsation cycle of the milking process. In an embodiment, an average sound pressure level or a peak sound pressure level may be measured during at least one of a resting phase and a milking phase of a pulsation cycle of the milking process. The inventor has determined that measurement of sound properties provides a avenue for checking the quality of the teatcup attachment.

It should be appreciated that this is not intended to be limiting, and that any suitable means of measuring properties of vibrational signals known to a person skilled in the art may be used to implement the present invention.

Preferably, the positioning of the teatcup is adjusted in response to the determined condition.

For example, if the present invention is implemented in a robotic milking machine and it is determined that the teatcup has fallen off, the teatcup applicator of the robot may be controlled to reapply the teatcup. Similarly, if it has been determined that the teatcup is incorrectly fitted to a teat, such a teatcup applicator may be controlled to reapply the teatcup.

In an embodiment of the present invention, an alarm may be issued in response to the determined condition. This may be by way of an alarm device such as a siren or light in order to alert an operator that action needs to be taken—particularly in milking systems without automated means for applying the teatcups. Alternatively (or additionally), the alarm may be a virtual notification or record within software monitoring or managing the milking process.

For a firmware and/or software (also known as a computer program) implementation, the techniques of the present invention may be implemented as instructions (for example, procedures, functions, and so on) that perform the functions described. It should be appreciated that the present invention is not described with reference to any particular programming languages, and that a variety of programming languages could be used to implement the present invention. The firmware and/or software codes may be stored in a memory, or embodied in any other processor readable medium, and executed by a processor or processors. The memory may be implemented within the processor or external to the processor.

A general purpose processor may be a microprocessor, but in the alternative, the processor may be any processor, controller, microcontroller, or state machine. A processor may also be implemented as a combination of computing devices, for example, a combination of a digital signal processor (DSP) and a microprocessor, a plurality of microprocessors, one or more microprocessors in conjunction with a DSP core, or any other such configuration. The processors may function in conjunction with servers and network connections as known in the art.

The steps of a method, process, or algorithm described in connection with the present invention may be embodied directly in hardware, in a software module executed by a processor, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

The present invention may provide at least the following advantages:
enhanced reliability and sensitivity by measuring vibrations within the cleaner environment of the airline in comparison with the milking line;
greater ease of compliance with hygiene regulations by eliminating interaction with milking line; and
minimised bulk and weight in the undercow milking apparatus by virtue of locating the sensing apparatus away from this point. This also reduces the likelihood of environmental conditions affecting sensor operation.

### BRIEF DESCRIPTION OF THE DRAWINGS

The features and advantages of the invention will be appreciated upon reference to the following drawings, in which:

FIG. 1 is a diagrammatic view of a milking device according to one embodiment of the present invention;

FIG. 2 is a side view of a robot arm for use according to one embodiment of the present invention;

FIGS. 3a-c illustrate extraction of milk using a milking device according to an embodiment of the present invention;

FIG. 4 is a diagram illustrating pressure levels over time in the pulsation space;

FIG. 5 is a cross-sectional view of a vibration sensor according to an embodiment of the present invention; and

FIGS. 6a-c are examples of measurements of a vibrational signal according to an embodiment of the present invention.

### DESCRIPTION OF ILLUSTRATIVE EMBODIMENTS

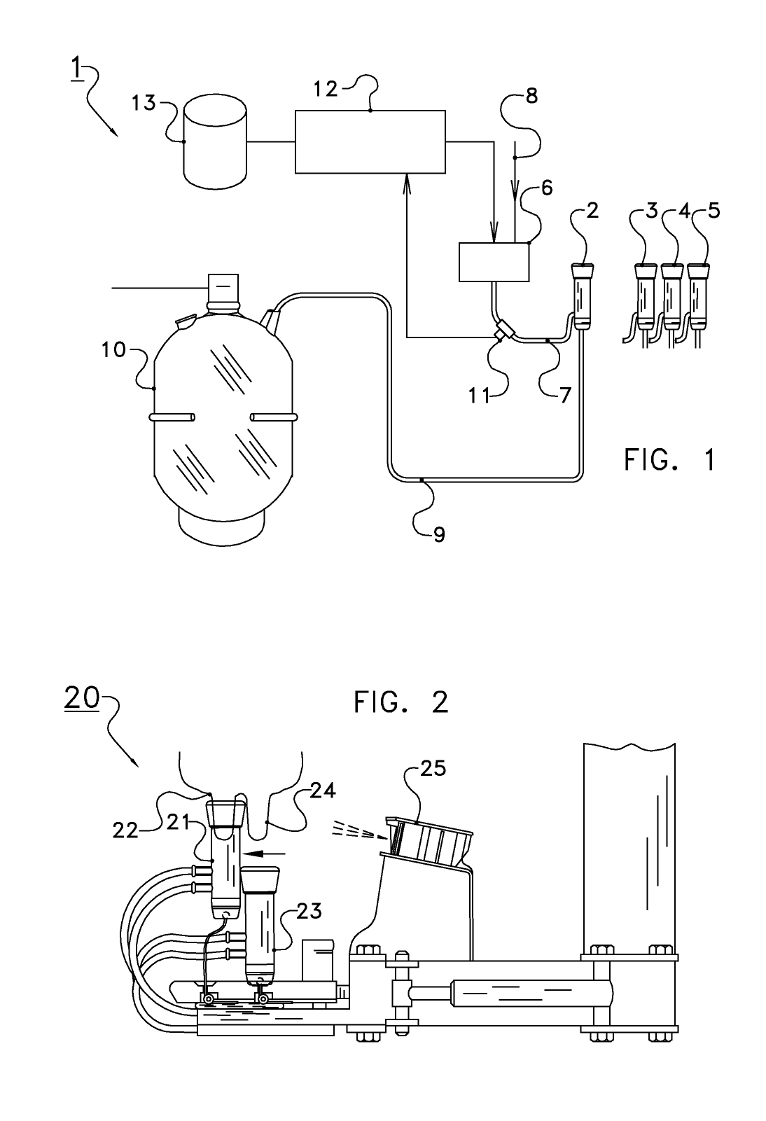

The following is a description of certain embodiments of the invention, given by way of example only and with reference to the drawings. FIG. 1 illustrates a milking device (generally indicated by arrow 1) for performing a milking process on a dairy animal (not illustrated). The device 1 includes four teatcups 2,3,4,5, each connected to a pulsator system 6 by way of individual airlines, exemplified by airline 7 which is associated with teatcup 2. The vacuum line 8 for the pulsator system 6 is connected in a usual manner to a vacuum pump with balance tank (not illustrated).

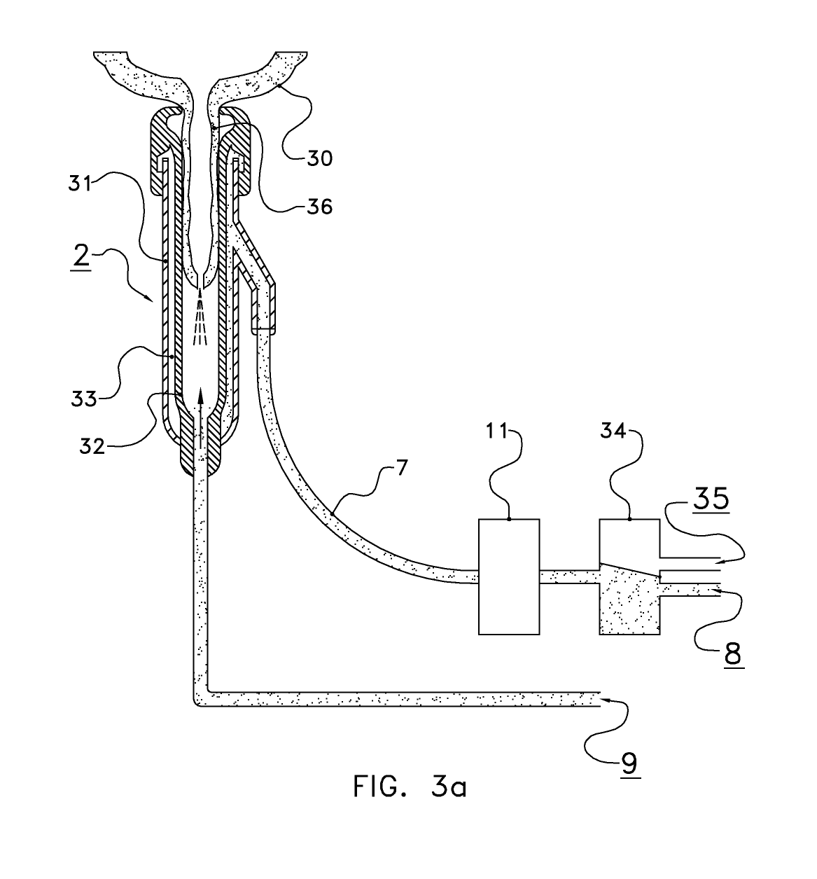

Each teatcup 2, 3, 4, 5 may be automatically connected and disconnected from a teat of a cow by means of a milking robot (as described with reference to FIG. 2).

FIG. 2 illustrates a robot arm (generally indicated by arrow 20) for connecting a first teatcup 21 to a first teat 22, and a second teatcup 23 to a second teat 24.

A position-determining device 25 detects the positions of the respective teats 22, 24 and teatcups 21, 23, and guides the teatcups 21, 23 to the teats 22, 24 such that vacuum attaches them.

Returning to FIG. 1, it should be appreciated that reference to the robot arm is not intended to be limiting, as it is envisaged that the teatcups may be applied manually.

The milk extracted by each teatcup 2, 3, 4, 5 is supplied via separate milk lines, exemplified by milk line 9 which is associated with teatcup 2, to a milk jar 10 and ultimately a milk tank (not illustrated).

Each teatcup 2, 3, 4, 5 is provided with a vibration sensor, exemplified by vibration sensor 11, within their respective airlines—for example airline 7 of teatcup 2—configured to measure at least one property of a vibrational signal within the airline.

The value of the measured property is sent from the sensor 11 to a processor 12. The processor 12 is also in communication with the pulsator system 6. It should be appreciated that the signals communicated from the sensor 11 and pulsator system 6 may include data identifying the respective sensor 11, pulsator within the pulsator system 6, and/or the teatcup 2,3,4,5.

Data transmitted to the processor 12 may be stored in memory 13, together with other data used in calculations performed by the processor 12, as described hereinafter.

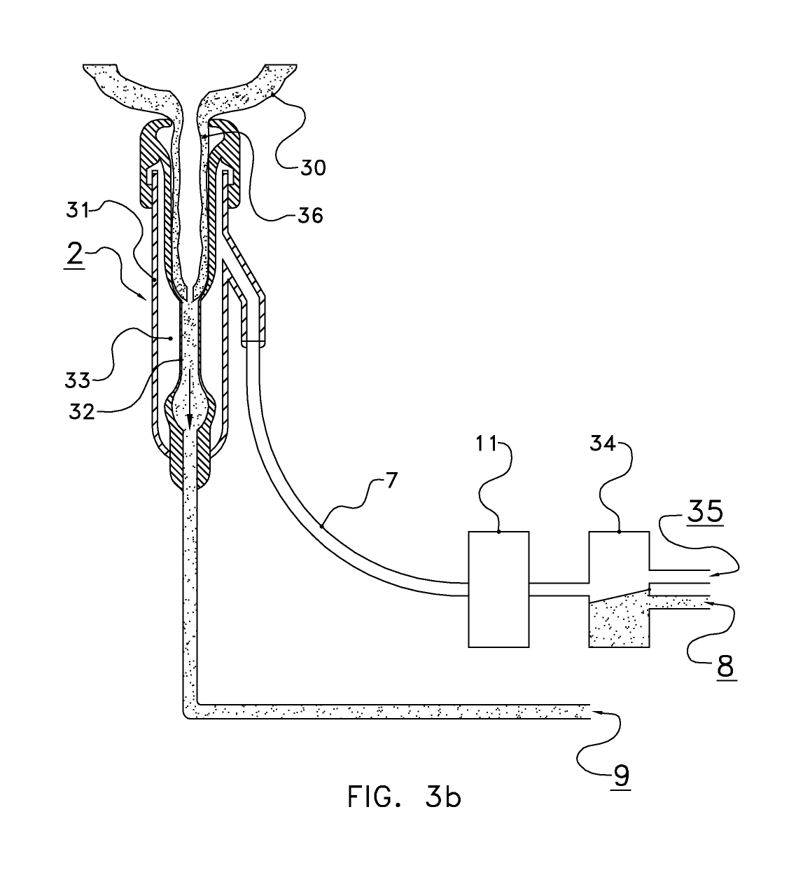

FIGS. 3a, 3b and 3c illustrate interaction of a dairy animal's udder 30 with a teatcup—for example, teatcup 2.

The teatcup 2 includes a shell 31 and a liner 32, between which a pulsation space 33 is formed. The liner 32 is connected to the milking line 9, while the pulsation space 33 is connected by the airline 7 to a pulsator 34, which forms part of the pulsator system 6 of FIG. 1.

The pulsator 34 acts as a valve, controlling connection of the airline 7 to vacuum 9 and atmospheric pressure 35.

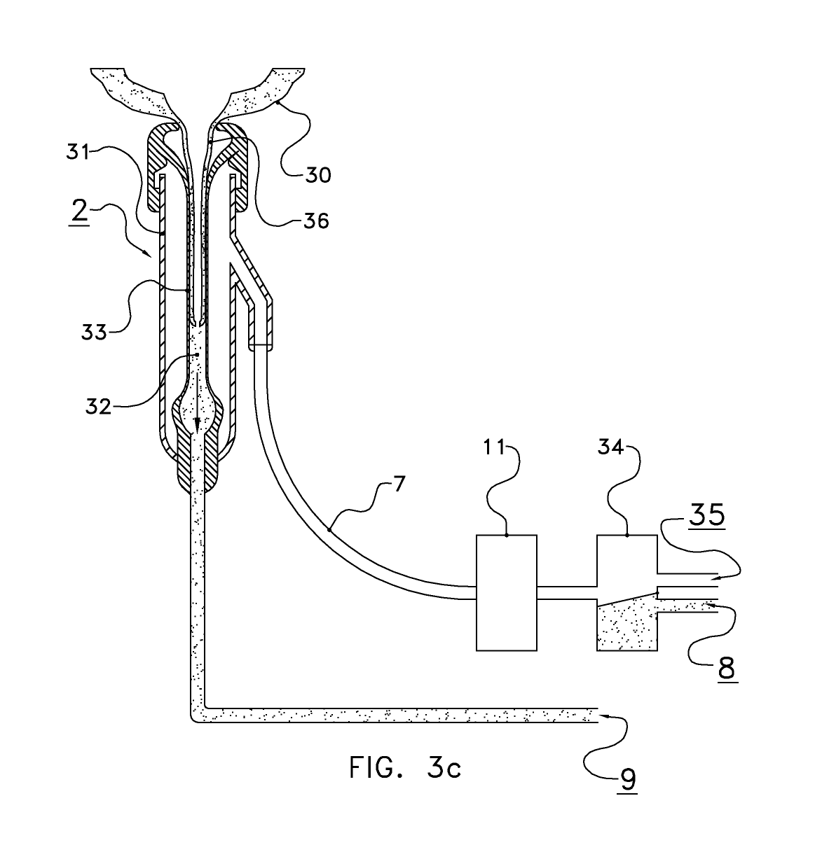

FIG. 4 illustrates a typical pulsation cycle, in which the pulsator 34 opens the airline 7 to vacuum 9. The vacuum levels build in phase A to a set vacuum level, which is maintained in phase B. The pulsator 34 then opens the airline 7 to atmospheric pressure 35. Pressure drops during phase C to atmospheric pressure in phase D.

Turning to FIG. 3a, during phases A and B the pressure within the milking line 9 and pulsation space 33 is balanced, causing the liner 32 to be drawn away from the teat 36. This allows the vacuum of the milking line 9 to draw milk out of the teat 36.

In FIG. 3b, during phases C and D the vacuum of the milking line 9 exceeds the pressure within the pulsation space 33, causing the liner 32 to collapse around the teat 36. This prevents milk from being extracted—providing a rest period for the dairy animal.

As illustrated by FIG. 3c, the teatcup 2 may be incorrectly applied to the udder 30—either missing a teat or forming an inefficient connection.

In each case, the vibration sensor 11 is positioned in the airline 7.

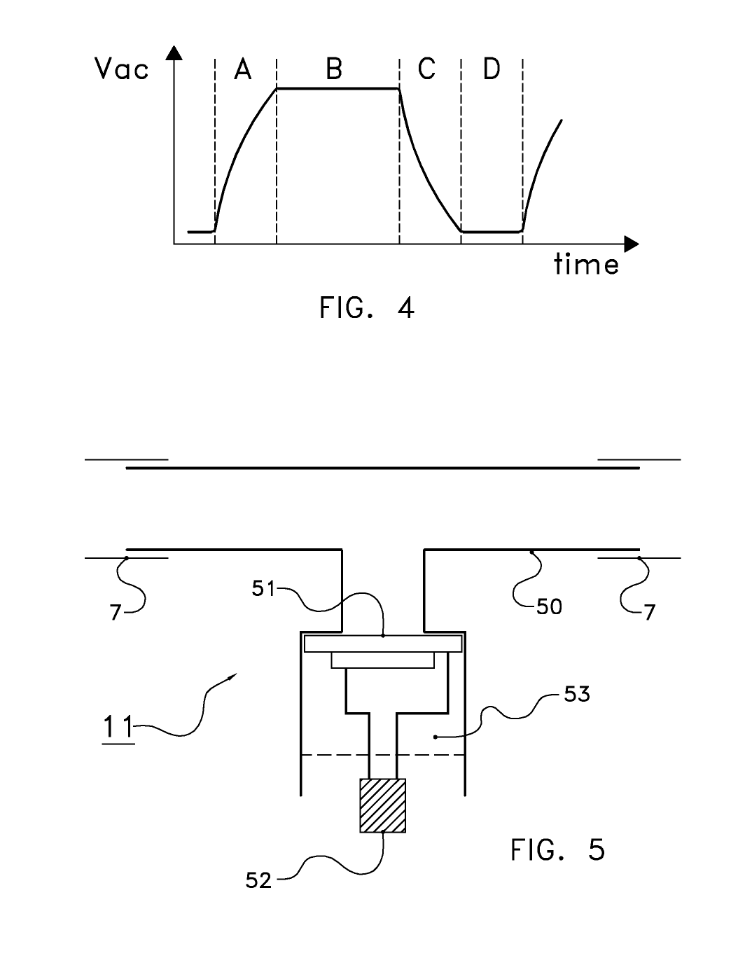

FIG. 5 illustrates one embodiment of the vibration sensor 11. A body of the sensor 11 is formed by a “T” section of tubing 50 which may be readily inserted into the airline 7.

A piezo element 51 is mounted within the tubing 50, exposed to the airline 7. A co-axial cable 52 connects the piezo element 51 to the processor 12 of FIG. 1. Epoxy resin 53 may be used to seal and fix the piezo element 52 in position.

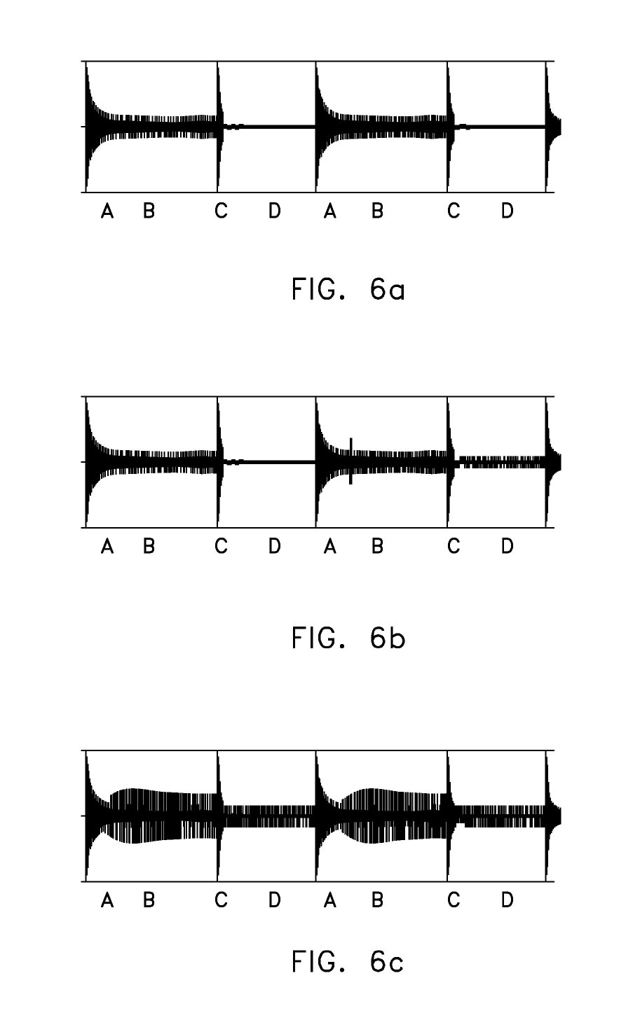

FIGS. 6a, 6b and 6c illustrate measurements of a vibrational signal made by the vibration sensor 11.

FIG. 6a illustrates the amplitude of acoustic signals in the airline 7 under normal milking conditions versus time. The phases of the pulsation cycle illustrated by FIG. 4 are marked accordingly.

It may be seen that the amplitude of the signal is greater during the A and B phases than during C and D.

FIG. 6b illustrates a scenario in which the teatcup 2 falls off during the second phase A of the series.

In doing so, the milking line 9 is exposed to atmospheric pressure, causing an inrush of air. This is particularly noticeable during phases C and D, when the amplitude of the signal would be expected to drop significantly due to the teatcup liner 32 collapsing about the teat 36 and preventing airflow.

The processor 12 may therefore determine the condition of a teatcup falling off by comparing the amplitude of the signal during at least phase D of the cycle with a reference value. The reference value may be, for example:
a predetermined value stored in the memory 13 connected to the processor 12;
a measured amplitude of the signal during a previous occurrence of the phase, or an average of several measurements.

It should be appreciated that the measurement for comparison with the reference value may be instantaneous amplitude, an average, deviation over a predetermined period, rate of change, or any other quantifiable means by which a comparison may be made with the reference value.

Further, the processor 12 may use measurements from phases other than D—although it is envisaged that phase D will provide the most reliable comparison.

If the processor 12 determines that the teatcup 2 has fallen off, it may control the robot arm 20 to reapply the teatcup 2 to the teat 36.

FIG. 6c illustrates a scenario in which the teatcup 2 is incorrectly connected to the teat 36, allowing air to flow past the teat 36 during phases A and B.

This accounts for the large spike in amplitude during phase B in particular, as compared with the normal milking conditions of FIG. 6a.

The processor 12 may compare measurements from phase B with reference values to determine whether the teatcup 2 is connected, albeit incorrectly. In doing so, the processor 12 may control the robot arm 20 to adjust the position of the teatcup 2 rather than attempting to relocate the teat 36 again.

It should be appreciated that there are multiple means for determining the phase of the milking process. The large transient signals at the start of phases A and C are due to the switching between vacuum and atmospheric pressure, and this together with amplitude of the acoustic signals in the airline 7 during the following phases may be used to determine phase. Alternatively, the processor 12 may be in communication with the pulsator system 6 and receive signals indicative of same.

In addition to, or in place of, adjusting the position of the teatcups, the processor 12 may be configured to issue an alarm regarding the detected condition. This may be by way of display of text or lights at the milking device or control module thereof, an audible alarm, a flag in software or any other suitable means known to a person skilled in the art.

In manually operated systems, this will enable the timely reapplication of the teatcup 2. In an automatic milking device, recordal of such alarms may allow for identification of ongoing faults requiring either recalibration of equipment, or repair or replacement of faulty components.

Further modifications in addition to those described above may be made to the structures and techniques described herein without departing from the spirit and scope of the invention. Accordingly, although specific embodiments have been described, these are examples only and are not limiting upon the scope of the invention.

What is claimed is:

1. A method of monitoring a milking process, the milking process performed by a milking apparatus including at least one teatcup with a pulsation space and at least one pulsation airline configured to deliver varying levels of pressure to the pulsation space, the method comprising the steps of:
measuring at least one property of a vibrational signal within the airline with a vibration sensor;
comparing a value of the measured property with a reference value; and
determining a condition of the milking process based on the comparison.

2. The method of claim 1, wherein determining the condition includes comparing an amplitude of the measured property with the reference value.

3. The method of claim 1, wherein determining the condition includes comparing deviation of the value of the measured property over time with the reference value.

4. The method of claim 1, wherein determining the condition includes comparing the rate of change of the measured property over time with the reference value.

5. The method of claim 1, wherein the method includes the step of:
determining a phase of one of the milking process or a pulsation phase.

6. The method of claim 5, wherein the property is measured during at least one selected phase.

7. The method of claim 6, wherein the property is measured during a phase in which the airline is exposed to atmosphere.

8. The method of claim 5, wherein the phase in which the property is measured is used to determine the reference value to be used in the comparison.

9. The method of claim 5, wherein the phase is determined by comparing the value of the measured property with a predetermined threshold.

10. The method of claim 1, wherein the property of the vibrations is measured using at least one of a piezoelectric transducer and a microphone.

11. The method of claim 10, wherein the property of the vibrational signal is an average sound pressure level or a peak sound pressure level.

12. The method of claim 11, wherein an average sound pressure level or a peak sound pressure level is measured at least during one of a resting phase and a milking phase of a pulsation cycle of the milking process.

13. The method of claim 1, wherein the condition is one of the teatcup being disconnected from a teat of the milking animal or the teatcup being incorrectly fitted to a teat of a milking animal.

14. The method of claim 1, including adjusting positioning of the teatcup in response to the determined condition.

15. A control device for monitoring a milking process, the milking process performed by a milking apparatus including at least one teatcup with a pulsation space and at least one pulsation airline configured to deliver varying levels of pressure to the pulsation space, the device including:
a vibration sensor configured to measure at least one property of vibrations within the airline; and
at least one processor configured to:
compare a value of the measured property with a reference value; and
determine a condition of the milking process based on the comparison.

16. A robotic automatic milking implement configured to perform a milking process, the implement including:
at least one teatcup configured to receive a teat of a milking animal, wherein the teatcup includes a pulsation space;
at least one airline configured to deliver varying levels of pressure to the pulsation space of the teatcup;
a robot arm configured to connect the teatcup to the teat; and
a vibration sensor configured to measure at least one property of vibrations within the airline; and
at least one processor configured to:
compare a value of the measured property with a reference value; and
determine a condition of the milking process based on the comparison.
